(19) United States
(12) Patent Application Publication
(10) Pub. No.: US 2014/0016318 A1
(43) Pub. Date: Jan. 16, 2014

(54) LED Light Assembly

(71) Applicant: Stevan Pokrajac, Windsor (CA)

(72) Inventor: Stevan Pokrajac, Windsor (CA)

(21) Appl. No.: 13/546,119

(22) Filed: Jul. 11, 2012

(51) Int. Cl. F21V 7/00

(52) U.S. Cl. CPC F21V 7/0083
USPC 362/247; 362/235

(57) ABSTRACT

An LED illumination device is provided. The device facilitates the use of thermoplastic reflectors using heat management principles.

### FIELD

The present disclosure relates to an illumination apparatus for an array of light emitting diodes.

### SUMMARY

This section provides a general summary of the disclosure, and is not a comprehensive disclosure of its full scope or all of its features.

According to the exemplary embodiments, the present teachings provide a light emitting diode (LED) illumination apparatus and a method of providing illumination. The apparatus comprises a reflector having a plurality of reflecting cavities, the reflecting cavities having an input aperture, an internal reflective sidewall defining an internal space and an output aperture. The reflector is coupled to an LED array containing at least one LED such that the input aperture is coupled in close proximity to at least one LED of the LED array and the input aperture of each reflecting cavity is annularly disposed about one of a plurality of LEDs of the LED array to allow light emitted from the plurality of LEDs to be received into the internal space, reflect off of the internal sidewall and transmitted out from the output aperture in order to project light from each LED for illumination.

Each input aperture may be located a predetermined distance from one of the LEDs, and the LEDs may be located at a pre-determined distance from the focal point of each corresponding reflecting cavity. The transverse axis of each input aperture may be aligned with a central vertical axis of its reflecting cavity and the center transverse axis of at least one of the LEDs may be located a predetermined radial distance from either of the transverse axis of its input aperture or the central vertical axis of its reflecting cavity.

In the exemplary embodiment, the LED array has a plurality of LEDs mounted directly upon a circuit board. The LED array is directly coupled to the reflector through reflector attachments such that LEDs are disposed within each corresponding input aperture, the center transverse axis of the LED is aligned with the transverse axis of its input aperture and the transverse axis of each input aperture is aligned with a central vertical axis of its reflecting cavity. The internal reflecting sidewall of the reflecting cavity of the exemplary embodiment defines a frusto-conical shaped internal space.

In the exemplary embodiment, the reflector is formed from a thermoplastic, such as fire-retardant ABS plastic and is coated with a light reflecting paint in order to enhance luminous reflectivity. The reflecting cavities of the reflector are integrally formed with the reflector, with the output apertures being defined in a substantially continuous surface.

Furthermore, the present teachings demonstrate a method of providing illumination. The method includes providing a thermoplastic reflector having a plurality of reflecting cavities defining an input aperture, a curved internal reflective sidewall having a focal location and defining an internal space and an output aperture in close proximity to the LED array and emitting light from the LED array into the internal space of the reflecting cavity. Upon entering the internal space of the reflective cavity through the input aperture, a portion of the light emitted from the LED array reflects off of the internal sidewall and out from the output aperture in order for project light from each LED for illumination.

Furthermore, the present teachings demonstrate a method of assembling an LED illumination apparatus. The steps include coupling a plurality of LEDs to a circuit board to form an LED array configured to emitting light, coupling a thermoplastic reflector having a plurality of reflecting cavities defining an input aperture, an internal reflective sidewall defining an internal space and an output aperture, said aperture being in close proximity to the LED array and mounting the coupled LED array and reflector to a housing and covering the output aperture with a light permeable material.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a block diagram of an illustrative embodiment according to the present teachings;

FIG. 2 is a flowchart illustrating the process of the present invention, according to an exemplary embodiment of the present invention;

FIG. 3 illustrates a circuit diagram demonstrating a particular exemplary embodiment of the present invention;

FIG. 4 is a set of timing diagrams illustrating the process of the present invention, according to the exemplary embodiment illustrated in FIG. 3;

FIG. 5 is a set of timing diagrams further illustrating the process of the present invention, according to the exemplary embodiment illustrated in FIG. 3; and

FIG. 6 is a set of timing diagrams further illustrating the process of the present invention, according to the exemplary embodiment illustrated in FIG. 3.

Corresponding reference numerals indicate corresponding parts throughout the several views of the drawings.

### DETAILED DESCRIPTION

Example embodiments will now be described more fully with reference to the accompanying drawings.

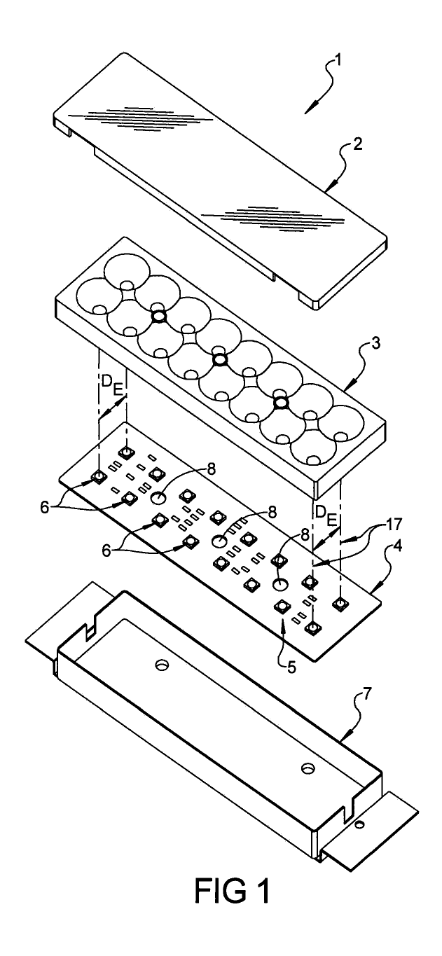

The components of the light emitting diode (LED) reflector apparatus 1 are set out generally in FIG. 1. The LED reflector apparatus has a reflector 3 coupled in close proximity to an LED array 4 containing one or more LEDs 6 which can, for example, be a surface mounted 1 watt LED. The LED array 4 is a circuit board 5 having the one or more LEDs 6 connected directly thereto, which circuit board 5 serves to supply power to and operational control of the LEDs 6. In an illustrated embodiment, the LEDs 6 are mounted directly upon the circuit board 5. The coupled LED array 4 and reflector 3 are mounted within a housing 7, and a cover plate 2 is configured to cover the LED Array 4 and reflector 3 when mounted within the housing 7. While the cover plate 2 can possess optical properties, the cover plate 2 does not need to be refractive or possess particularly advantageous optical features (other than being formed from a relatively transparent material which allows light to pass through), rather, its main function is to protect the operational components of the LED array 4, specifically, the LEDs 6.

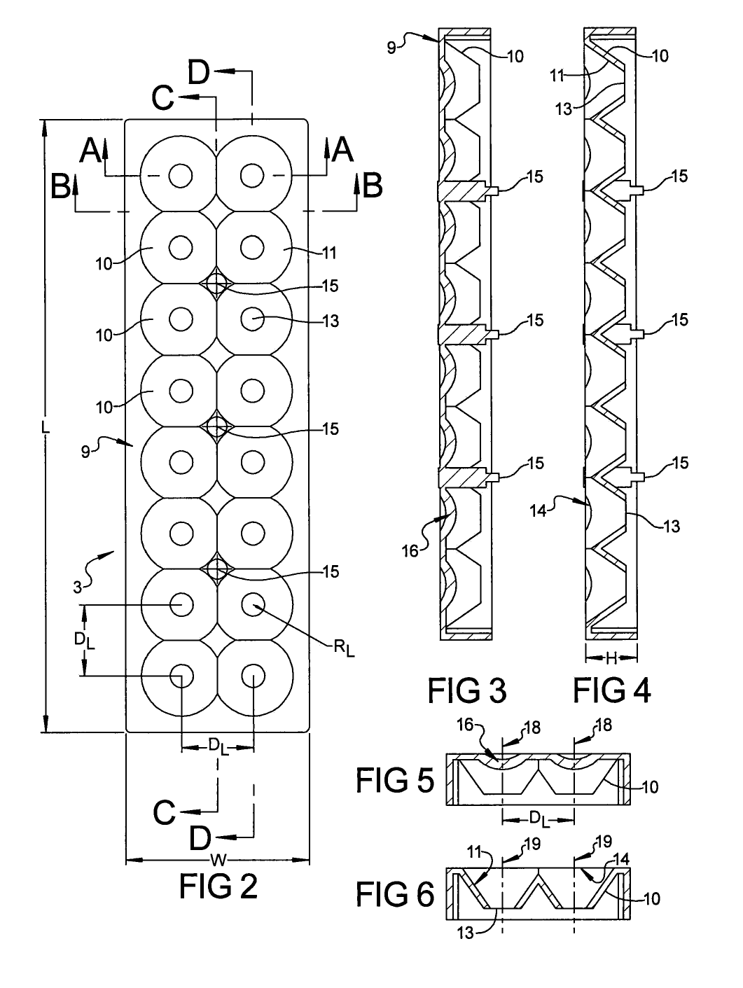

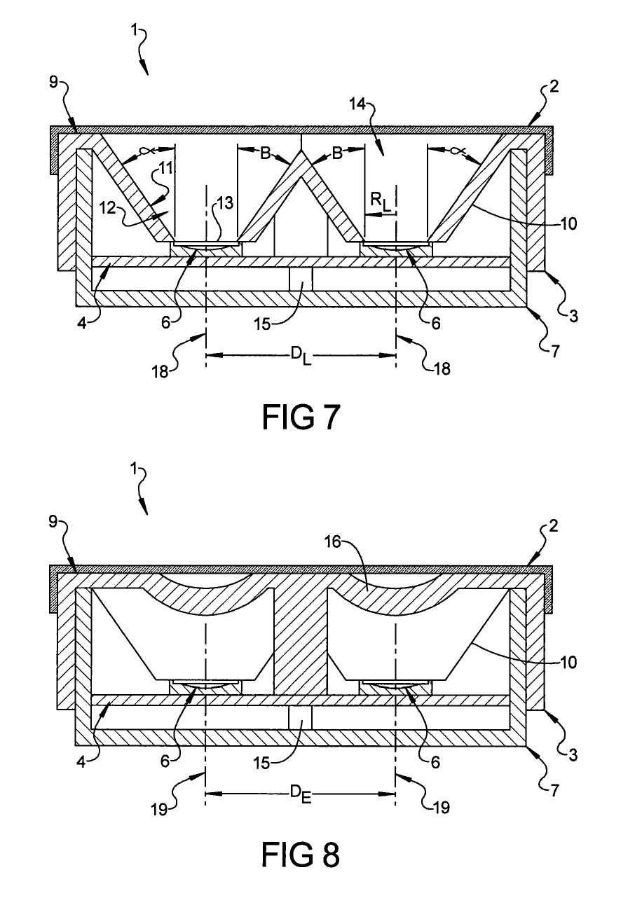

The reflector 3 further has one or more reflecting cavities 10, the number of reflecting cavities 10 corresponding to the number of LEDs 6 comprising LED array 4. When coupled to the LED array 4, the reflecting cavities 10 of the LED array 4 are annularly disposed upon each LED 6 (as discussed in detail below), such that activation of each LED 6 (i.e., application of current through the LED array 4) combined with reflective effects of the reflecting cavity act as the source of illumination, with each LED 6 acting as point source of light. In the embodiment of FIGS. 2 to 8, the reflector is in direct contact with the LED array 4 (as discussed below). The reflective ability of the reflector 3, and correspondingly, each reflecting cavity 10, is enhanced through the use of a reflective coating paint

As illustrated in the embodiment of FIGS. 1, 7 and 8, the reflector 3 is secured to the LED array 4 through the use of reflector attachments 15. Optionally, these attachments 15 can be elongated members protruding out from the bottom surface of the reflector 3. The reflector attachments 15 can be secured to support holes 8 disposed upon the circuit board 5 using any standard form of adhesive or being secured simply through frictional engagement of the reflector attachments 15 and the circuit board 5. The corresponding positioning of the reflector attachments 15 and the support holes 8 are such that the reflector 3 is positioned with each LED reflecting cavity 10 being immediately disposed upon each corresponding LED 6 (as illustrated by the broken lines in FIG. 1).

Each LED reflecting cavity 10 is configured so as to receive light emanating from each LED 6 and project it outward from each LED reflecting cavity 10. With reference to the embodiment of FIGS. 2, 7 and 8, each LED reflecting cavity 10 has an LED input aperture 13 which annularly disposed upon each corresponding LED 6 and the reflector 3 is in direct contact with the LED array 4. Extending upward from the input aperture 13 is a continuous internal sidewall 11, which extends to form an LED output aperture 14 opposing the input aperture 13. The sidewall 11 defines an interior space 12 within the reflecting cavity 10. The reflecting cavity 10 receives light from its corresponding point source LED 6 via the input aperture 13, and illumination occurs when light is reflected from the internal wall 11 out through the output aperture 14.

The embodiment illustrated in FIGS. 3 to 8 illustrate each LED reflecting cavity 10 as having sidewalls forming a frusto-conical configuration for each reflecting cavity 10. However, various other shapes and configurations fall within the scope of the current invention (as discussed below), such as for example and not limited to parabolic, elliptical, segmented, polygonal, etc., depending on the requirements of each specific application. As best illustrated in FIG. 7, the reflector 3 is secured to the LED array 4 via the reflector attachments 15 such that the input aperture 13 of each reflective cavity 10 is annularly disposed upon each corresponding LED 6. Furthermore, the LEDs 6 are generally located at a pre-determined distance from the focal point of each corresponding reflecting cavity 10, and in the illustrated embodiment, the LEDs 6 are mounted directly upon circuit board 5.

Additional operational components (which have not been specifically illustrated) include but are not limited to a power supply and/or controller connected to the LED array 4, which power supply/controllers being known in the art, and well within the purview of one skilled in the art, for controlling illumination of single or multiple LED's and other operational factors such as activation, brightness, etc. Such components fall within the purview of one skilled in the art and the application and operation of such components in order to work the present invention would be obvious to such a skilled person.

FIGS. 1-6 serve as a detailed schematic representation of an embodiment of the reflector apparatus 1, with FIGS. 2-6 representing the reflector 3 of the embodiment. With reference to FIG. 2 illustrating an embodiment, the LED array 4 comprises a 2×8 array of LEDs 6, each mounted directly upon circuit board 5, and accordingly the reflector 3 comprises a 2×8 array of corresponding reflecting cavities 10. FIG. 2 represents a top view of the reflector 3. In this embodiment, the reflector 3 comprises a single, monolithic unit formed by an injection molding process. The reflector 3 can be formed entirely from any standard ABS plastic capable of being molded by any one of a number of processes well known in the art, but is preferably formed using ABS-FR (fire retardant) plastic in order to conform to commercial regulations of various jurisdictions. The formed reflector 3 is then coated with non-metallic, reflective paint, such as vacuum coating.

With reference to FIG. 2, the top face 9 of the reflector 3 forms a substantially continuous surface at the output aperture 14 into the internal sidewalls 11 of the reflecting cavities 10, which continuous surface forms the input apertures 13 of each respective reflecting cavity 10 at its outermost edge. With reference to FIGS. 2, 3 and 5, given the monolithic form of the reflector 3 of the preferred embodiment, each reflecting cavity 10 is interconnected to the adjacent cavity at a point of continuous interconnection 16 located at the outer edge of each adjacent output aperture 14. Likewise, in the embodiment exemplified in FIGS. 2-4, the reflector attachments 15 for securing the reflector 3 to the LED array 4 can be integrally formed as part of the monolithic reflector 3. In the design of one embodiment illustrated in FIG. 2, the various reflecting cavities 10 are arranged to produce a combined illumination output, such that the entire reflector 3, with the 2×8 array of LEDs 6, acts as a single ‘bulb’ or ‘lamp’ providing an output of light.

As illustrated in the embodiment of FIG. 2, each input aperture 13 is positioned such that it is substantially central to each corresponding reflecting cavity 10. Specifically, the transverse axis of each respective input aperture 13 is aligned with the central vertical axis of its corresponding reflecting cavity 10. However, depending on the particular illumination requirements, including the particular angle of illumination required in a specific application, the input aperture 13 may be located in an off-center position relative to the corresponding central vertical axis of the reflecting cavity 10, i.e. altering angles α and/or β as illustrated in FIG. 7.

As discussed above, the LED array 4 of the illustrated embodiment is comprised of one or more LEDs 6 mounted directly to the circuit board 5, which circuit board 5 serves to supply power to and operational control of the LEDs 6. Operable connection of the LEDs to the circuit board 5 can be accomplished using any of the various wiring arrangements known in the art, including wiring the LEDs 6 in series, parallel or some combination of both. Mounting and connection of the LEDs and other electrical components of the circuit board 5 can be accomplished through the use of techniques well within the purview of one skilled in the art, including solder/bump connections. However, in the illustrated embodiment, the LED array 4 preferably operates in such fashion with minimal heat generation so as to avoid damaging the reflector 3 which is formed of plastic material, and input apertures 13 being in close proximity, if not in direct contact with the LEDs 6. While other LED illumination devices known in the art incorporate methods of heat dissipation into the device, such as a heat sink incorporated into the LED array or circuit board, these devices may still generate enough heat to cause deformation of the reflector 3 if the reflector 3 is in direct contact with the LED array 4. As such, it is recommended that the LED reflector apparatus 1 incorporate an LED driver capable providing LED illumination with minimal heat generation (so as to avoid causing heat deformation of the reflector 3), such as that disclosed in U.S. patent application Ser. No. 13/525,703 and incorporated by reference herein, which is capable of operating with an LED 6 temperature of less than or equal to 32° C.

FIGS. 7 and 8 provide a detailed illustration of the reflecting cavity 10 contained within the fully assembled LED reflector apparatus 1. The reflecting cavity 10 has a reflecting internal sidewall 11 formed by the continuous surface of the top face 9 of the reflector 3, the internal sidewall 11 defining an internal space 12. The outermost edge of the internal sidewall 11 forms the LED input aperture 13 located at the bottom of the reflecting cavity 10. The reflecting cavity 10 of the illustrated embodiment is substantially frusto-conical shaped with the top portion of the reflecting cavity 10, where the cavity meets the top face 9 of the reflector 3 forms the output aperture 14 for illumination.

As best illustrated in FIG. 7, the input aperture 14 is configured so as to substantially match the shape of the corresponding LED 6, in order to allow the input aperture 13, and correspondingly the reflector 3, to be annularly disposed immediately upon the LED 6. While the embodiment illustrates an input aperture 13 having circular configuration, any shape or configuration may be used, including without limitation square or hexagonal, in order to provide symmetrical matching of the input aperture 14 to the specific corresponding LED 6 utilized in the LED array 4.

The internal sidewall 11 of the reflecting cavity 10 is coated with light reflecting paint in order to enhance the luminous reflectivity. The light emitted from each LED 6 via the input aperture 13 is reflected off of the internal sidewalls 11 of the reflecting cavity 10 and then outward from the output aperture 14 to provide illumination. The internal sidewall 11 has an internal angle α from the vertical axis and external angle β from the vertical axis, which angles define the frusto-conical shape of the reflecting cavity 10. As discussed above, in the illustrated preferred embodiment, the input aperture 13 is centralized at the bottom of the reflecting cavity 10 such that the transverse axis of the input aperture 13 is aligned and overlaps with the central vertical axis of the reflecting cavity 10. However, by altering angles α and/or β one skilled in the art can move the input aperture 13 to an off-center position based on specific illumination requirements for specific applications. In the preferred embodiment of FIGS. 7 and 8, reflecting cavity 10 has equal sidewall angles α and β. However, optimum values for angles α and β depend on the specific application and desired characteristics of illumination output, and such modifications would be well within the purview of one skilled in the art.

The illustrated embodiment depicts each LED 6 as being congruent and in an overlapping position with each respective input aperture 13 when reflector 3 is coupled to the LED array 4, in that the center transverse axis 17 of the LED 6 is aligned with the transverse axis 18 of its input aperture 13, and the transverse axis 18 of each input aperture 13 can be aligned with a central vertical axis 19 of its reflecting cavity 10. It is possible for one skilled in the art to alter the positioning of each LED 6 in relation to its respective input aperture 13, in order to move the LED 6 to a slightly ‘off-center’ position in relation to its respective input aperture 13 (i.e., D_{L} the distance between the transverse axis 18 of adjacent input apertures 13 is greater or less than D_{E}, the distance between the center transverse axis 17 of adjacent LEDs 6). Furthermore, it is possible to offset the transverse axis 18 of the input aperture 13 from the central vertical axis 19 of the respective reflecting cavity 10, thus offsetting the center of the LED a predetermined distance from the axis of the reflector 3. While altering the value of sidewall angles α and β has the effect of changing the breadth of dispersion of light from the output aperture 14, off-centering LEDs 6 vis-à-vis the corresponding input aperture 13 has the effect of altering the focal point of the light, to a greater or lesser distance from the reflector 3. As such, depending on the requirements of a particular application, one skilled in the art may position the center transverse axis 17 of the LED at a predetermined radial distance from either of the transverse axis 18 of its input aperture or the central vertical axis 19 of its reflecting cavity. Also, depending on the requirements of a particular application, which may or may not require the focusing of light from the output aperture 14 to a particular focal point, one skilled in the art, through a combination of optimizing the values or angles α and/or β and distances D_{L} and D_{E}, can achieve the desired illumination dispersement and focal point.

In the illustrated embodiment, all of the LEDs 6 comprising the LED array 4 are all disposed upon the same horizontal plane, which plane is parallel to that of the top face 9 of the reflector 3. Accordingly, light emitting from the LEDs 6 can be evenly reflected onto the internal sidewall 11 of each reflecting cavity 10. However, one skilled in the art would readily appreciate that the plane of the LED array 4, or individual LEDs 6 can be varied so as to effect the angle of light from the LED 6 reflecting from the internal sidewall 11, and ultimately from the output aperture 14 in order to effect the desired angle of illumination required.

Again referencing FIGS. 7 and 8, the reflector 3 is secured to the LED array 4 via the support attachments 15. Support attachments 15 are secure the reflector 3 to the LED array 4 through the support holes 8 positioned upon the LED array 4. The attached reflector/LED array are then positioned into the housing 7. As illustrated in FIG. 7, the top face 9 of the reflector 3 hangs over and around the outer surface of the housing, loosely securing the reflector/LED array into place in the housing 7. If required, any form of adhesive can be used along the underside of the reflector 3 in order to secure the reflector/LED array to the housing. Likewise, the cover plate 2 can be secured to the reflector 3 using any form of well-known adhesive if required.

Referencing the preferred embodiment illustrated in FIGS. 2 and 5-8, the reflector 3 consists of an array of 2×8 reflecting cavities 10. In the preferred embodiment, length L of the reflector 3 is approximately 8.3 inches, width W is approximately 2.4 inches and height H is approximately 0.7 inches. D_{L} represents the distance between the center point of adjacent input apertures 13. In the preferred embodiment, D_{L} is approximately 1 inch, and D_{L} is equal both for reflecting cavities 10 which are horizontally and vertically adjacent (with reference to FIG. 2). Furthermore, in the exemplary embodiment, the distance between centers of adjacent LEDs 6 is equal to D_{L}.

Referring to FIG. 7, R_{L} represents the radius of each input aperture 13. In the preferred embodiment, R_{L} is equal to approximately ¼ inch. Furthermore, angles α and β can be 20°-45°, and preferably about 35°.

With respect to the specific operating conditions of the embodiment of FIGS. 2 to 8, the LED array 4 utilizes Samsung™ LEDs, (model SPMWHT520A), the size of which correspond with the shape and dimensions of input aperture 13 so as to permit the input aperture 13 of the reflecting cavity 10 to be annularly disposed immediately upon the LED 6, with the LED 6 disposed within the input aperture 13, and in direct contact with LED array 4. Preferably the LEDs 6 will have an illumination of approximately 200 LUX, at an LED 6 temperature of less than or equal to 32° C., at an input current to the LED array 4 of approximately 160 milliamps, which results in an approximate 3.6 to 4 volt drop per LED 6 and an approximate power consumption of ¼ to ½ watt per LED 6 for a total power consumption of 4 watts/hour.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A light emitting diode (LED) illumination apparatus, comprising:
a reflector having a plurality of reflecting cavities, the reflecting cavities comprising an input aperture, an internal reflective sidewall defining an internal space and output aperture;
a LED array containing at least one LED coupled in close proximity to the reflector input aperture;
wherein the input aperture of each reflecting cavity is annularly disposed about one of a plurality of LEDs of the LED array to allow light emitted from the plurality of LEDs to be received into the internal space, reflect off of the internal sidewall and transmitted out from the output aperture in order to project light from each LED for illumination.

2. The apparatus of claim 1, wherein each input aperture is a predetermined distance from one of the LEDs.

3. The apparatus of claim 1, wherein the reflector is formed from a thermoplastic.

4. The apparatus of claim 1, wherein the reflector is coated with light reflecting paint in order to enhance luminous reflectivity.

5. The apparatus of claim 1, wherein the plurality of reflecting cavities of the reflector are integrally formed with the reflector with the output apertures being defined in a substantially continuous surface.

6. The apparatus of claim 1, wherein the temperature of at least one LED during operation is less than or equal to about 32° C. when driven so as to emit an illumination of at least 200 LUX.

7. The apparatus of claim 1, wherein the internal reflecting sidewall of the reflecting cavity defines a frusto-conical shaped internal space.

8. The apparatus of claim 1, wherein the internal reflective sidewall has an internal angle about 35° from the vertical axis and external angle about 35° from the vertical axis.

9. The apparatus of claim 1, wherein the LED array is directly coupled to the reflector through reflector attachments.

10. The apparatus of claim 1, wherein the transverse axis of each input aperture is located a pre-determined radial distance from the central vertical axis of its reflecting cavity.

11. The apparatus of claim 1, wherein a transverse axis of each input aperture is aligned with a central vertical axis of its reflecting cavity.

12. The apparatus of claim 1, wherein the LED is generally located at a pre-determined distance from the focal point of each corresponding reflecting cavity.

13. The apparatus of claim 1, wherein the plurality of LEDs are mounted directly upon a circuit board and disposed within the input aperture.

14. The apparatus of claim 1, wherein at least one of the LEDs has a center transverse axis located a predetermined radial distance from either of the transverse axis of its input aperture or the central vertical axis of its reflecting cavity.

15. A method of providing illumination comprising:
a LED array;
providing a thermoplastic reflector having a plurality of reflecting cavities defining an input aperture, a curved internal reflective sidewall having a focal location and defining an internal space and an output aperture in close proximity to the LED array;
emitting light from the LED array into the internal space;
wherein the light emitted from the LED array enters the internal space of the reflecting cavity through the input aperture, a portion of the emitted light reflects off of the internal sidewall and out from the output aperture in order to project light from each LED for illumination.

16. The method of claim 14, further including directly coupling the reflector to the LED array.

17. The method of claim 14, further including driving the LED array to emit more than 200 LUX and maintaining the temperature of the thermoplastic reflector at less than about 32° C.

18. The method of claim 14, wherein providing a thermoplastic reflector is providing a reflector defining a frusto-conical shaped internal space.

19. The method of claim 14, wherein the transverse axis of each input aperture is aligned with the central vertical axis of its reflecting cavity.

20. The method of claim 18, wherein each LED has a central axis and at least one LED central axis is a predetermined radial distance from the focal location.

21. A method of assembling an LED illumination apparatus comprising:
coupling a plurality of LEDs to a circuit board to form an LED array configured to emitting light;
coupling a thermoplastic reflector having a plurality of reflecting cavities defining an input aperture, an internal reflective sidewall defining an internal space and an output aperture, said aperture being in close proximity to the LED array; and
mounting the coupled LED array and reflector to a housing and covering the output aperture with a light permeable material.

22. The method of claim 20, wherein the reflector is in direct contact with the circuit board.

23. The method of claim 20, wherein the internal reflecting sidewall of the reflecting cavity defines a frusto-conical shaped internal space having a focal point and a central focal axis.

24. The method of claim 20, wherein the transverse axis of each input aperture is aligned with the central focal axis of its reflecting cavity.

25. The method of claim 22, wherein at least one LED has a central LED axis being offset from the central focal axis and the focal point.
